(19) United States
(12) Patent Application Publication
(10) Pub. No.: US 2004/0229666 A1
(43) Pub. Date: Nov. 18, 2004

(54) Case for mobile communication terminal

(75) Inventor: Choong Jae Lee, Euiwang (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/841,071

(22) Filed: May 6, 2004

(30) Foreign Application Priority Data
May 12, 2003 (KR) 29906/2003

(51) Int. Cl. H04M 1/00

(52) U.S. Cl. 455/575.1; 455/575.3

(57) ABSTRACT

Disclosed is a mobile communication terminal having an upper case coupled to a lower case. A primary rib is formed on the inner sides of upper case's edges and a plurality or secondary ribs is formed along the inner sides of the lower case's edge. The plurality of secondary ribs engages the primary rib when the upper case is coupled to the lower case. Grooves are formed on the top surfaces of the ribs to interlock and prevent lateral and longitudinal movement of one case with respect to another.

### CROSS-REFERENCE TO RELATED APPLICATIONS

Pursuant to 35 U.S.C. § 119(a), this application claims the benefit of earlier filing date and right of priority to the Korean Patent Application No. 2003-29906, filed on May 12, 2003, the content of which is hereby incorporated by reference in its entirety.

### BACKGROUND OF THE INVENTION

1. Field of the Invention

The present invention relates to a mobile communication terminal, and, more particularly, to a case for a mobile communication terminal.

2. Description of Related Art

A mobile communication terminal (hereinafter, referred to as ‘terminal’) is a portable device by which voice, message and image information can be transmitted/received through a wireless medium. Recently, terminals having multimedia function besides the simple voice transmitting/receiving function are being developed.

As mobile communication service and manufacturing technology improve, terminals have become smaller in size. Furthermore, many terminals are now constructed as a folding type mobile terminal, which offers the advantages of larger display screens and better ergonomics with respect to use and portability. Currently, many terminals, including the folding-type, utilize liquid crystal display (LCD) screens for display purposes. In order to protect the LCD screens, the screens are installed on the inner side of one of the folding members of the terminal. However, as terminals and terminal components become smaller in size, display screens correspondingly grow in size. Furthermore, second display screens are now increasingly being offered, wherein the second screen is installed on the outer surface of the terminal opposite to the main display screen. Due to increasing compactness of terminals and growth of display screen size, terminals and display screens become more susceptible to damage or malfunction due to external impact, such as dropping.

In FIG. 1, a conventional folding type terminal is shown, which includes a first folding member 8 that houses a plurality of terminal manipulation devices 4 on its inner surface, exemplified here as keys of a keypad. One particular key, the menu button 2, is shown also. A power source 6, shown here as a battery, is installed on the outer surface of the first member 8. The second folding member 10 is rotatably connected to the first member 8. A main display screen 12 is installed on the inner surface of the second member 10.

Referring to FIG. 2, an exploded perspective view of the second member 10 is shown. The second member 10 includes an upper case 104 housing a second display screen (not shown), wherein a user views information displayed in the second display screen through a display window 102. The upper case 104 couples to the lower case 106 to form the second member 10 via screws drawn through holes 112 in the upper case 104 and engage grooves 114 in the lower case 106. The lower case 106, which forms the inner surface of the second member 10, includes a hinge unit 108 to rotatably couple the second member 10 to the first member 8. The lower case 106 also includes a display window 110, through which a user views information displayed on the main display screen 12. Within Section A of FIG. 2 are support parts 120 and 122 for protecting the LCD screen and other circuitry housed in the second member 10.

FIG. 3 is an enlarged view of the Section A in FIG. 2. In FIG. 3, the support part 120 is shown as a rib formed with a predetermined length at both edges of the upper case 104. The support part 122 is shown as a slot formed at both edges of the lower case 106 and receives the support rib 120. FIG. 4 illustrates a sectional view of the second member 10, wherein the upper and lower cases are coupled. Also shown in FIG. 4 is the impact force P, which is applied vertically to the surface of the upper case 104, as shown by the direction arrow.

Section B in FIG. 4, which is enlarged in FIG. 5, illustrates the sectional view of the support rib 120 engaging the support slot 122. The width L of the support slot 122 is often very small, generally less than 1 mm. The depth M of the support slot 122 is generally greater than three times the width L. The difference is size between M and L allows for elasticity when the terminal is compressed by the force P. However, when the upper and lower cases 104, 106 are manufactured, which is often by injection molding of polymers, the support ribs and slots 120, 122 must be formed to small and exact measurements. Due to the long and narrow formation of the support ribs and slots 120 and 122, respectively, they are fragile in construction and are easily damaged during fabrication, thereby increasing the cost of manufacturing.

FIG. 6 illustrates a cross-sectional view of the conventional folding type terminal from the side, wherein a force Q is applied to the terminal in the direction signified by the arrow. In this case, the benefits provided by the arrangement of the support slots and ribs 120, 122 do not apply. The force Q would deform the terminal so that the upper case 104 of the second member 10 would be bent outwardly and the support rib 120 would be disengaged from the support slot 122. Consequently, the upper case 104 would be decoupled from the lower case 106 and a gap therebetween would be created. Accordingly, there is a need for a construction of a mobile terminal to prevent deformation of the case and subsequent internal damage that may result from physical impact.

### SUMMARY OF THE INVENTION

The present invention is directed to a case for mobile communication terminal that substantially obviates one or more problems due to limitations and disadvantages of the related art above.

An object of the present invention is to provide a case that would not deform and sufficiently tolerate impacts applied in vertical and horizontal directions to a surface of the case.

Another object of the present invention is to provide a case for a mobile communication terminal having reduced fabrication cost and increased durability.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, there is provided a mobile communication terminal comprising: a first casing comprising a primary rib formed approximately parallel and adjacent to a side edge; and a second casing coupled to the first casing, wherein the second casing comprises a plurality of secondary ribs formed along a side edge so that the plurality of secondary ribs engage the primary rib when the second casing is coupled to the first casing.

According to one aspect of the present invention, the terminal may further comprise a support wall formed approximately parallel and adjacent to the side edge of the second casing, wherein an inner surface of the support wall is adjacent to the plurality of secondary ribs.

According to another aspect of the present invention, the primary rib may comprise a plurality of support grooves that is formed on the primary rib and that corresponds to the plurality of secondary ribs. Furthermore, each secondary rib may comprise comprises an engaging groove formed on the secondary rib to engage the plurality of support grooves when the second casing is coupled to the first casing. Also, each support groove may be tapered and formed approximately perpendicular to the primary rib.

According to another aspect of the present invention, each secondary rib may comprise an engaging groove formed on the secondary rib to engage the primary rib when the second casing is coupled to the first casing.

It is to be understood that both the foregoing general description and the following detailed description are exemplary and explanatory and are intended to further describe the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates a perspective view of a conventional folding-type mobile communication terminal;

FIG. 2 illustrates another view of the conventional folding-type mobile communication terminal of FIG. 1;

FIG. 3 illustrates an enlarged view of Section A of FIG. 2;

FIG. 4 illustrates a partial sectional view of the conventional folding-type mobile communication terminal of FIG. 1;

FIG. 5 illustrates an enlarged view of Section B of FIG. 4;

FIG. 6 illustrates a side view of the conventional folding-type mobile communication terminal of FIG. 1 undergoing a state change from physical impact;

FIG. 7 illustrates a perspective view of a member of a folding-type mobile communication terminal in accordance with a preferred embodiment of the present invention;

FIG. 8 illustrates an enlarged view of Section C of FIG. 7;

FIG. 9 illustrates a sectional view of the member of a folding-type mobile communication terminal in accordance with a preferred embodiment of the present invention;

FIG. 10 illustrates an enlarged view of Section D of FIG. 9;

FIG. 11 illustrates an enlarged view of Section E of FIG. 9;

FIG. 12 illustrates a perspective view of the upper and lower cases of the member prior to coupling, in accordance with a preferred embodiment of the present invention; and

FIG. 13 illustrates a perspective view of the upper and lower cases coupled in accordance with a preferred embodiment of the present invention.

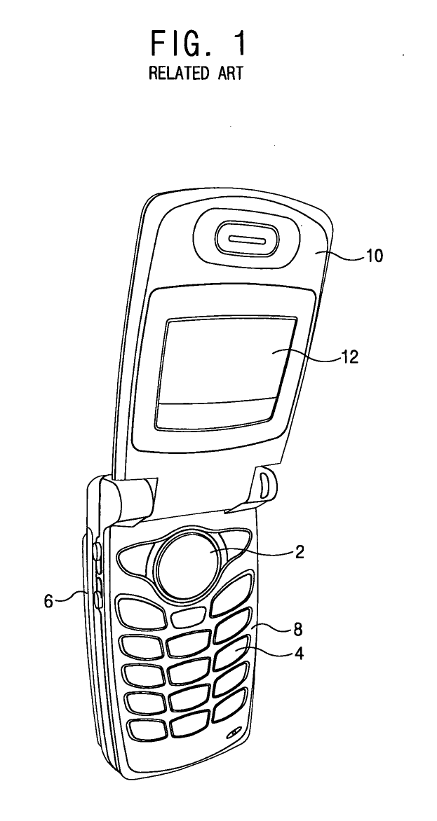

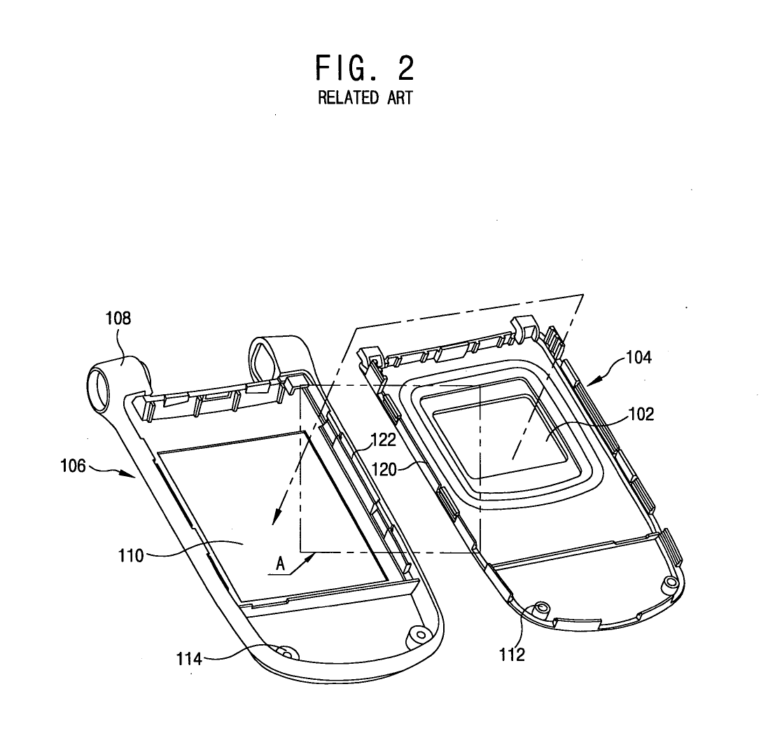

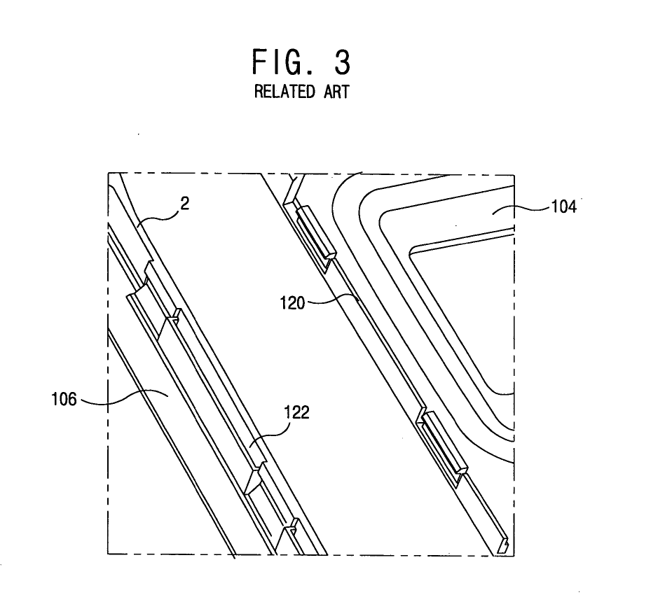

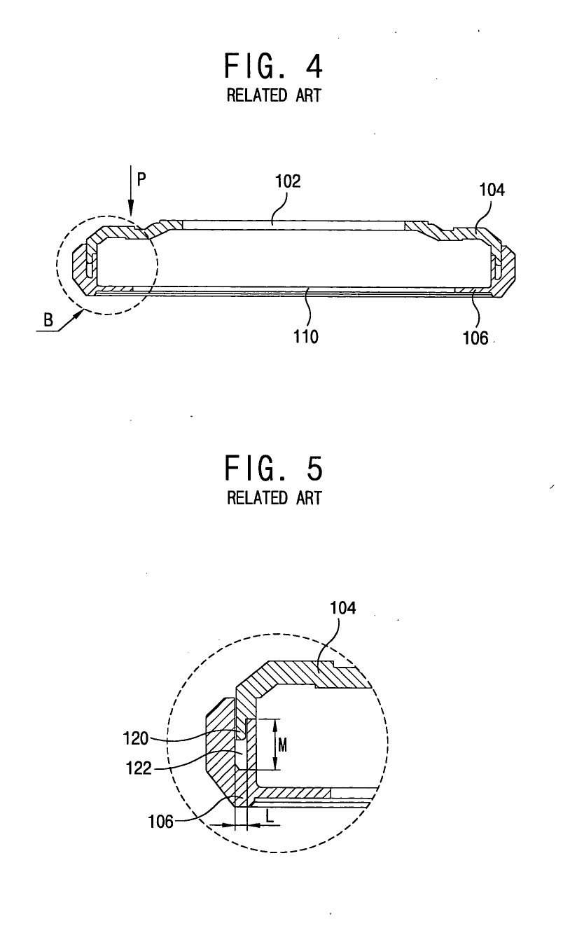

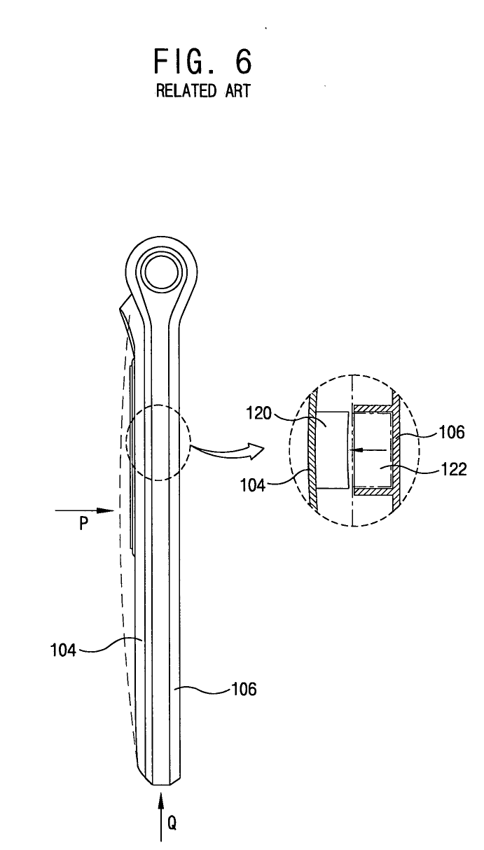

Features, elements, and aspects of the invention that are referenced by the same numerals in different figures represent the same, equivalent, or similar features, elements, or aspects in accordance with one or more embodiments.

### DETAILED DESCRIPTION OF THE PREFERRED EMBODIMENTS

Reference will now be made in detail to one or more embodiments of the invention, examples of which are illustrated in the accompanying drawings.

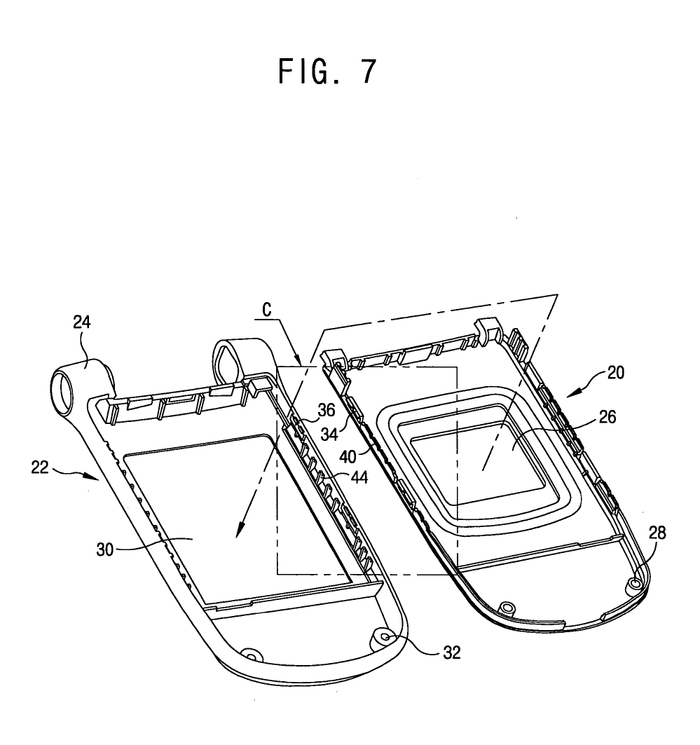

Referring to FIG. 7, a second member of the mobile communication terminal comprises an upper case 20 housing a second display screen (not shown), wherein a user views information displayed in the second display screen through a display window 26. The upper case 20 couples to the lower case 22 to form the second member via screws that protrude through holes 28 in the upper case 20. The screws subsequently engage grooves 32 in the lower case 22. The lower case 22, which forms the inner surface of the second member, includes a hinge unit 24 to rotatably couple the second member to a first member (not shown). The lower case 22 also includes a display window 30, through which a user may view information displayed on the main display screen (not shown).

Within Section C of FIG. 7 are one or more pairs of locking hooks 34 and 36, which are formed on the lateral edges of the upper and lower cases 20 and 22, respectively. When the upper and lower cases 20 and 22 are coupled, the hooks 34 and 36 mutually engage each other to prevent the upper and lower cases 20 and 22 from separating. Preferably, the hooks 34 and 36 mutually engage each other via snap-fit. A primary rib 40 is formed on the lateral edges of the upper case 20 and corresponds to a plurality of secondary ribs 44 formed on the lateral edges of the lower case 22. Preferably, the secondary ribs 44 are formed at equal intervals along the lateral edges of the lower case 22. Due to the plurality of support mechanisms formed on the edges of the upper and lower cases 20, 22, the overall structural strength of the second member of the mobile communication terminal is improved.

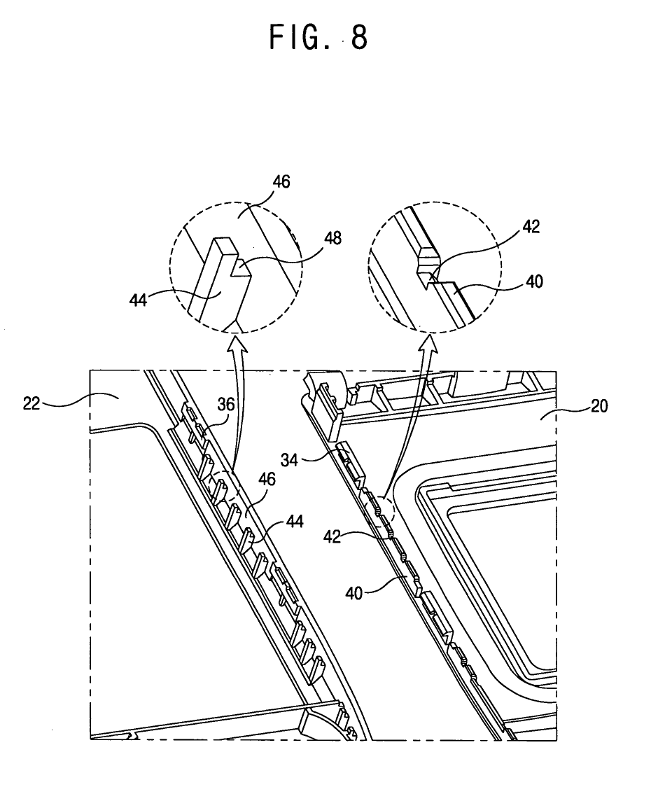

Referring to FIG. 8, which is an enlarged view Section C in FIG. 7, a plurality of support grooves 42 is formed on the primary rib 40. The plurality of support grooves 42 receives the plurality of secondary ribs 44 when the upper and lower cases 20 and 22 are coupled. Preferably, the support grooves 42 are formed at equal intervals that correspond to the intervals between the secondary ribs 42. A support wall 46 is formed on the outer edges of the lower case 22, wherein the secondary ribs 44 are formed adjacent to the support wall 46. In alternative embodiments, the support wall may be integrated into the outer edge of the lower case 22.

An engaging groove 48 is preferably formed on the distal end of each secondary rib 44, wherein the engaging groove 48 is approximately “L” shaped. Accordingly, the vertically portion of each engaging groove 48 is approximately parallel and adjacent to the primary rib 40 when the upper and lower cases 20 and 22 are respectively coupled. Furthermore, the horizontal portion of the engaging groove is approximately perpendicular to the primary rib 40 when engaging the support groove 42. Preferably, the width and depth of the plurality of engaging grooves 48 are approximately equal to the width and depth of the plurality of support grooves 42. In order to facilitate coupling, the support grooves 42 are preferably tapered so that the entrance of each groove 42 is formed wide.

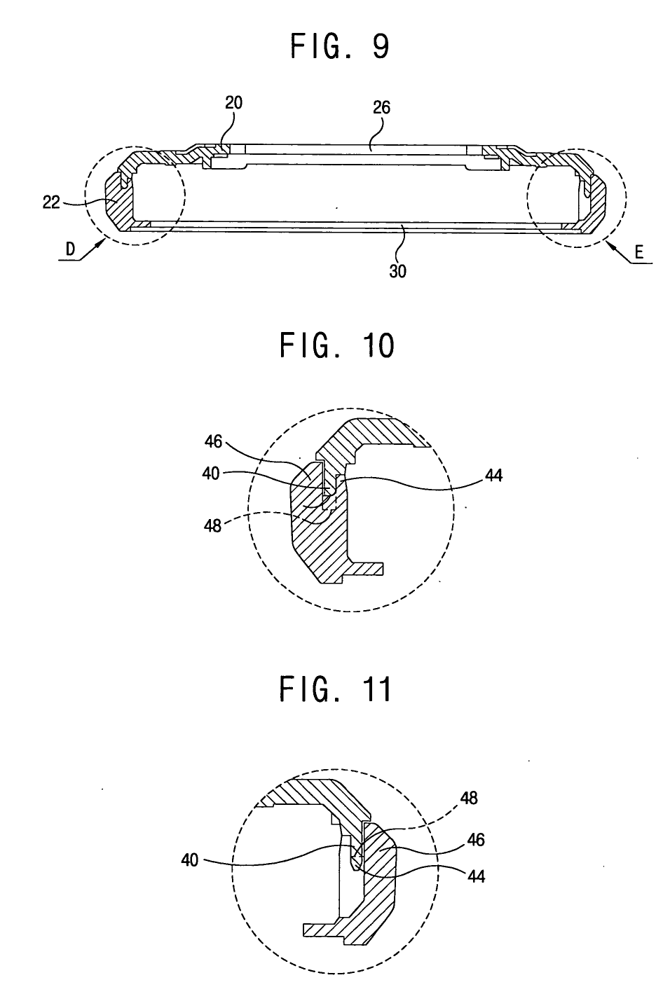

Referring to FIG. 9, a sectional view of the second member of a folding-type mobile communication terminal, in accordance with a preferred embodiment of the present invention, is shown. Particularly, the coupling of the upper and lower cases 20 and 22 can be viewed, wherein the side edges of the cases in Sections D and E are enlarged in FIGS. 10 and 11, respectively. FIGS. 10 and 11 show alternating views of the primary and secondary ribs 40 and 42, wherein the engaging grooves 48 and the support grooves 42 mutually receive each other.

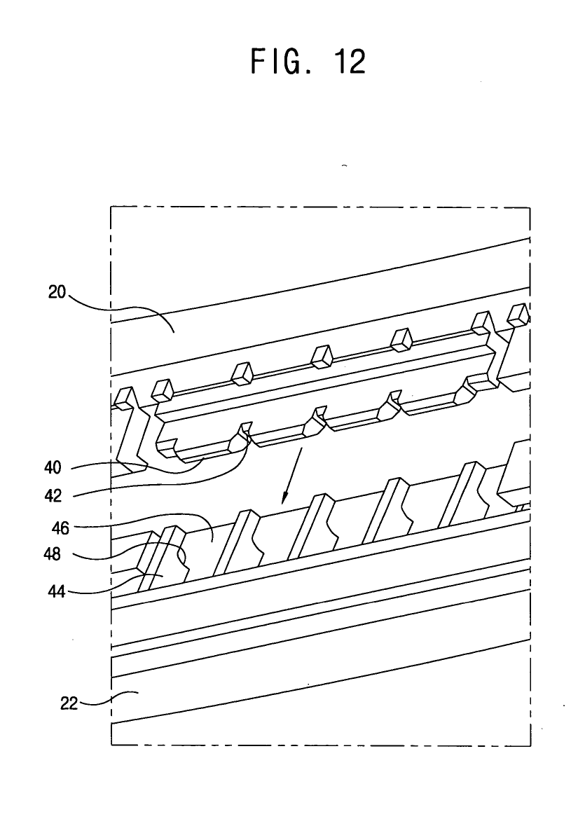

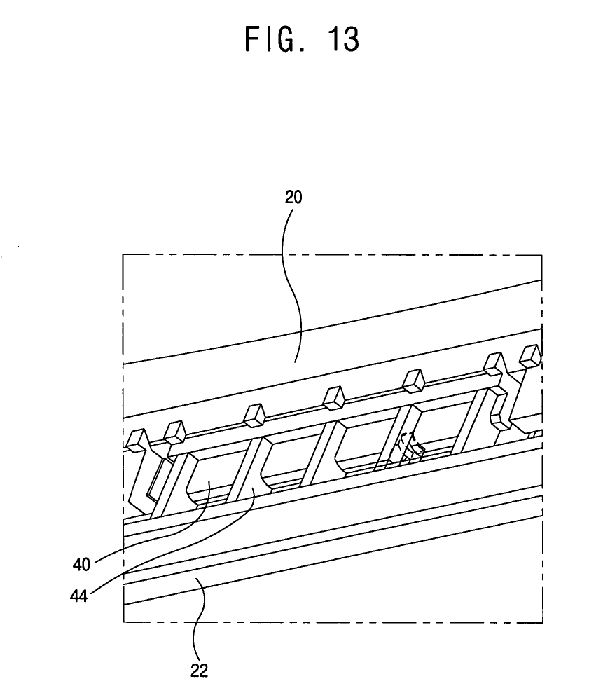

FIGS. 12 and 13 illustrate the process of coupling the upper and lower cases 20 and 22 of the second member in accordance with a preferred embodiment of the present invention. As shown in FIG. 12, the upper case 20 is coupled to the lower case, wherein the hooks 34 and 36 mutually engage each other to interlock (not shown). Screws are driven through the holes 28 of the upper case and engage the grooves 32 formed on the lower case 22, thereby securely fastening the upper and lower cases 20 and 22. In FIG. 13, the primary rib 40 is shown to be operatively coupled with the plurality of secondary ribs 44. Furthermore, the relationship between the plurality of support grooves 42 and the plurality of engaging grooves 48 is evidenced by the dotted lines.

Accordingly, a mobile communication terminal having a case constructed according to a preferred embodiment of the present invention would be able to withstand impact forces applied in either or both vertical and horizontal directions. The engagement of the plurality of support grooves 42 and the engaging grooves 48 prevent longitudinal movement of the upper and lower cases 20 and 22 when a longitudinal force (i.e., perpendicular to the upper or lower side edges of either the upper or lower cases 20, 22) is applied. Also, the plurality of secondary ribs 44 provides sufficient strength and durability to withstand the application of a lateral force (i.e., perpendicular to the surface of either the upper or lower cases 20, 22).

The support wall 46 allows for the second member to withstand forces applied to the lateral side edges of the lower case, thereby further preventing the upper and lower cases 20 and 22, respectively, from sliding apart. The support wall eliminates the need to fabricate a relatively fragile support slot, thereby reducing the number of defective units produced and, subsequently, overall fabrication costs.

It will be apparent to those skilled in the art that various modifications and variations can be made in the present invention without departing from the spirit or scope of the invention. Therefore, the foregoing description of these embodiments of the present invention has been presented for the purposes of illustration and description, without the intention to be exhaustive or to limit the invention to the precise form disclosed. The present invention covers the modifications and variations of this invention provided they come within the scope of the appended claims and their equivalents. Preferred embodiments were shown in the context of folding type mobile communication terminals. In alternative embodiments, candy bar type mobile communication terminals, PDA terminals, and pagers can be substituted for the present invention.

What is claimed is:

1. A mobile communication terminal comprising:
a first casing comprising a primary rib formed approximately parallel and adjacent to a side edge; and
a second casing coupled to the first casing, wherein the second casing comprises a plurality of secondary ribs formed along a side edge so that the plurality of secondary ribs engage the primary rib when the second casing is coupled to the first casing.

2. The mobile communication terminal of claim 1, further comprising a support wall formed approximately parallel and adjacent to the side edge of the second casing, wherein an inner surface of the support wall is adjacent to the plurality of secondary ribs.

3. The mobile communication terminal of claim 1, wherein the primary rib comprises a plurality of support grooves that is formed on the primary rib and that corresponds to the plurality of secondary ribs.

4. The mobile communication terminal of claim 3, wherein each secondary rib comprises an engaging groove formed on the secondary rib to engage the plurality of support grooves when the second casing is coupled to the first casing.

5. The mobile communication terminal of claim 3, wherein each support groove is tapered and is formed approximately perpendicular to the primary rib.

6. The mobile communication terminal of claim 3, wherein the plurality of support grooves and the plurality of secondary ribs are placed equidistantly apart.

7. The mobile communication terminal of claim 1, wherein each secondary rib comprises at least an engaging groove formed on the secondary rib to engage the primary rib when the second casing is coupled to the first casing.

8. The mobile communication terminal of claim 1, wherein a plurality of hooks is formed on the first and second casings so that a hook of the first casing is operatively coupled with a hook of the second casing, when the second casing is coupled to the first casing.

9. The mobile communication terminal of claim 1, wherein the terminal is a folding type mobile terminal.

10. The mobile communication terminal of claim 1, wherein the terminal is a candy bar type mobile terminal.

11. A mobile communication terminal comprising:
a first member;
a power source installed on an outer surface of the first member;
a plurality of terminal manipulation devices installed on an inner surface of the first member;
a second member comprising an upper casing and a lower casing, wherein an outer surface of the second member is formed on the upper casing and an inner surface of the second member is formed on the lower casing;
a main display screen installed on the inner surface of the second member;
a hinge installed on the lower casing that rotatively couples the second member to the first member;
a primary rib having a length and formed approximately parallel and adjacent to an inner side surface of the upper casing;
a support wall formed approximately parallel and adjacent to an inner side surface of the lower casing;
a plurality of secondary ribs formed approximately perpendicular and adjacent to an inner side surface of the support wall;
an engaging groove formed on a top surface of each secondary rib, wherein the engaging groove is approximately “L” shaped and oriented so that the engaging groove is approximately parallel to the secondary rib; and
a plurality of support grooves formed on a top surface of the primary rib along its length, wherein each support groove is approximately perpendicular to the primary rib and engages each engaging groove.

12. A case comprising:
a first casing;
a second casing that couples to the first casing;
a primary rib having a length and formed approximately parallel and adjacent to an inner side surface of the first casing;
a support wall formed on an inner side surface of the second casing;
a plurality of secondary ribs formed approximately perpendicular and adjacent to an inner side surface of the support wall; and
an engaging groove formed on a top surface of each secondary rib, wherein each engaging groove engages the primary rib when the first and second casings are coupled.

13. The case of claim 12, further comprising a plurality of support grooves formed on a top surface of the primary rib along its length, wherein the plurality of support grooves corresponds to the plurality of secondary ribs.

14. The case of claim 13, wherein each support groove is formed approximately perpendicular to the primary rib.

15. The case of claim 12, wherein the engaging groove is approximately “L” shaped and oriented so that the engaging groove is approximately parallel to the secondary rib.

16. The case of claim 12, further comprising one or more pairs of corresponding locking hooks formed adjacent to the inner side surfaces of the first and second casings, wherein the locking hooks mutually engage each other via a snap-fit construction.

17. The case of claim 12, wherein the case comprises a polymer and is fabricated via injection molding.
